(19) United States
(12) Patent Application Publication
(10) Pub. No.: US 2009/0290016 A1
(43) Pub. Date: Nov. 26, 2009

(54) ENDOSCOPE SYSTEM

(75) Inventor: Tadaaki SUDA, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/466,450

(22) Filed: May 15, 2009

(30) Foreign Application Priority Data
May 20, 2008 (JP) 2008-131926
May 20, 2008 (JP) 2008-132161

(51) Int. Cl. H04N 7/18

(52) U.S. Cl. 348/65; 348/E07.085

(57) ABSTRACT

An endoscope system comprises a scope and a processor. The scope has an imaging sensor, a first image-processing unit that performs primary image processing, a first memory, and a second memory. The first and second memories are non-volatile. The processor has a second image-processing unit that performs secondary image processing, and a processor memory that is non-volatile. The first memory stores an system data that includes parameters for the primary and secondary image processing. The processor memory stores the system data. The second memory is used for storing the system data stored in the processor memory when it is determined that the system data stored in the first memory is older than the system data stored in the processor memory. The system data stored in the second memory is overwritten onto the first scope memory after the system data is stored in the second memory.

### BACKGROUND OF THE INVENTION

1. Field of the Invention

The present invention relates to an endoscope system that simplifies the updating of the scope or processor.

2. Description of the Related Art

An endoscope system that has a scope including an imaging sensor is proposed.

The parameters for image processing or the firmware for the scope are set in the scope, with consideration given to the characteristics of the processors that may possibly be connected to this scope.

Similarly, the parameters for image processing or the firmware for the processor are set in the processor, with consideration given to the characteristics of the scopes that may possibly be connected to this processor.

However, it is difficult to set the parameters for image processing etc., when giving consideration to all of the characteristics of the various devices that will be developed in the future.

Therefore, the endoscope system that can update the parameters for image processing etc., after shipping is required.

Japanese unexamined patent publication (KOKAI) No. 2000-245681 discloses an endoscope system that updates the firmware by receiving the firmware data transmitted from an external device such as a personal computer or the like.

However, when the endoscope system updates the firm ware, it is necessary to connect the external device to the endoscope system. Therefore, an operator who has knowledge of this connection and the data transmission is necessary.

### SUMMARY OF THE INVENTION

Therefore, an object of the present invention is to provide an endoscope system that can easily update the parameter for image processing and the firmware for the scope and the processor, without connecting to the external device.

According to the present invention, an endoscope system comprises a scope and a processor.

The scope has an imaging sensor, a first image-processing unit that performs primary image processing on an image signal obtained by the imaging sensor, a first scope memory for image processing, and a second scope memory for updating. The first scope memory and the second scope memory are non-volatile.

The processor has a second image-processing unit that performs secondary image processing on the image signal after the primary image processing, a first processor memory for image processing, and a second processor memory for updating. The first processor memory and the second processor memory are non-volatile.

The first scope memory stores system data that includes parameters used for the primary and secondary image processing, or includes firmware for the scope and the processor.

The first processor memory stores the system data.

The second scope memory is used for storing the system data stored in the first processor memory, when it is determined that the system data stored in the first scope memory is older than the system data stored in the first processor memory.

The second processor memory is used for storing the system data stored in the first scope memory, when it is determined that the system data stored in the first processor memory is older than the system data stored in the first scope memory.

After the system data is stored in the second scope memory, the system data stored in the second scope memory is overwritten onto the first scope memory.

After the system data is stored in the second processor memory, the system data stored in the second processor memory is overwritten onto the first processor memory.

### BRIEF DESCRIPTION OF THE DRAWINGS

The objects and advantages of the present invention will be better understood from the following description, with reference to the accompanying drawings in which:

FIG. 1 is a construction diagram of the endoscope system in the first and second embodiments;

FIG. 2 is a flowchart that shows the procedure for updating the system data in the first embodiment; and

FIG. 3 is a flowchart that shows the procedure for updating the system data in the second embodiment.

### DESCRIPTION OF THE PREFERRED EMBODIMENTS

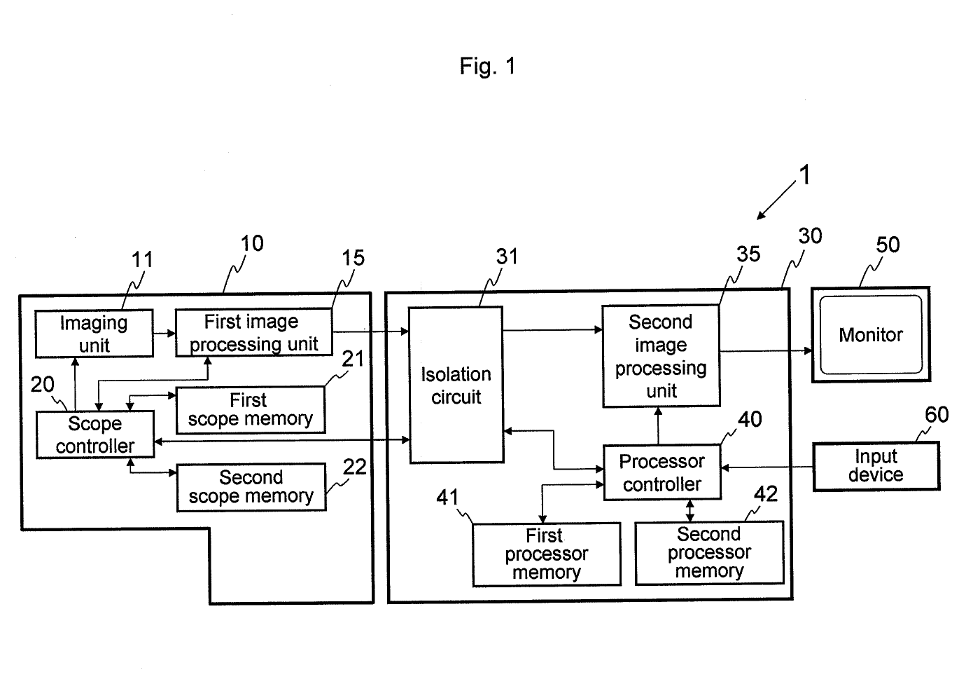

The present invention is described below with reference to the embodiments shown in the drawings. As shown in FIG. 1, an endoscope system 1 in the first embodiment comprises a scope 10, a processor 30, a monitor 50, and an input device 60.

The scope 10 has an imaging unit 11 including an imaging sensor such as a CCD or the like, a first image-processing unit (image-processing circuit) 15 such as a DSP or the like, a scope controller 20, a first scope memory 21 for image processing, and a second scope memory 22 for updating. In the first embodiment, the first scope memory 21 is non-volatile and the second scope memory 22 is volatile.

The processor 30 has an isolation circuit 31, a second image-processing unit (image-processing circuit) 35 such as a DSP or the like, a processor controller 40, a first processor memory 41 for image processing, and a second processor memory 42 for updating. In the first embodiment, the first processor memory 41 is non-volatile and the second processor memory 42 is volatile.

The first image-processing unit 15 performs primary image processing such as a YC separation or the like, on the image signal obtained by the imaging unit 11.

The processor 30 performs secondary image processing on the image signal after the primary image processing, so as to generate the image (the video signal) that can be displayed on the monitor 50.

In the first embodiment, it is defined that the first scope memory 21 and the first processor memory 41 are the primary memory, and that the second scope memory 22 and the second processor memory 42 are the secondary memory.

The monitor 50 is connected to the processor 30. The monitor 50 displays the image in conformity with the standard of the predetermined video signal, upon which the primary image processing and the secondary image processing are performed by the scope 10 and the processor 30.

Furthermore, the input device 60 such as a keyboard or the like is connected to the processor 30.

The external memory that stores the image data, etc., based on the image signal, may be connected to the processor 30. Furthermore, the printer may also be connected to the processor 30.

Next, the details of the endoscope system 1 are explained.

The reflection of the photographic subject based on the illumination of the endoscope system 1 reaches the imaging sensor of the imaging unit 11 through the objective optical system (not depicted), and the optical image of the subject is imaged on the incident surface of the imaging sensor of the imaging unit 11. At the imaging sensor, the photoelectric conversion operation of the optical image is performed and then the image signal based on the optical image is output.

The image signal output from the imaging unit 11 is transmitted to the first image-processing unit 15 of the scope 10. The first image-processing unit 15 performs the primary image processing of the image signal, such as the YC separation that separates the luminance (Y) signal and the chrominance (C) signal of the image signal, etc.

The image signal after the primary image processing is transmitted to the second image-processing unit 35 of the processor 30, through the isolation circuit 31. The isolation circuit 31 protects the patient from electric shock, etc.

The second image-processing unit 35 performs the secondary image processing so as to generate the video signal that can be displayed on the monitor 50.

The first scope memory 21 stores system data that are used for the primary image processing by the first image-processing unit 15 and for the secondary image processing by the second image-processing unit 35. The system data are composed of parameters that are grouped by each model of scope that can be connected to the processor 30 and by each model of processor that can be connected to the scope 10.

The parameters include a gamma characteristic, an enhancement, a limit value of the luminance signal, etc.

The parameters among the system data that correspond to the active scope 10 that is presently connected to the processor 30, are used for the primary image processing by the first image-processing unit 15.

Furthermore, the system data are also stored in the first processor memory 41. When it is determined by communication between the scope controller 20 and the processor controller 40 that either the system data in the first scope memory 21 or the system data in the first processor memory 41 is older than the other system data, the other system data, which is newer data, is written over the older system data so that the older system data is updated.

The first image-processing unit 15 reads out the parameters, which are necessary for the primary image processing, from the system data stored in the first scope memory 21, when the scope 10 is connected to the processor 30 and when the main power supply of the endoscope system 1 is set to the ON state.

The parameters, which are read by the first image-processing unit 15, are temporarily stored in the first image-processing unit 15 and are used for the primary image processing, while the scope 10 is connected to the processor 30 and while the main power supply of the endoscope system 1 is set to the ON state.

The second scope memory 22 is used for temporarily storing the system data stored in the first processor memory 41 in order to prepare for updating the system data stored in the first scope memory 21, when it is determined that the system data stored in the first scope memory 21 is older than the system data stored in the first processor memory 41.

The first processor memory 41 stores the system data, similarly to the first scope memory 21.

The second processor memory 42 is used for temporarily storing the system data stored in the first scope memory 21 in order to prepare for updating the system data stored in the first processor memory 41, when it is determined that the system data stored in the first processor memory 41 is older than the system data stored in the first scope memory 21.

The second image-processing unit 35 reads out the parameters, which are necessary for the secondary image processing, from the system data stored in the first processor memory 41, when the scope 10 is connected to the processor 30 and when the main power supply of the endoscope system 1 is set to the ON state.

The parameters, which are read by the second image-processing unit 35, are temporarily stored in the second image-processing unit 35 and are used for the secondary image processing, while the scope 10 is connected to the processor 30 and while the main power supply of the endoscope system 1 is set to the ON state.

In the first embodiment, the scope controller 10 and the processor controller 40 communicate with each other and compare the version of the system data stored in the first scope memory to the version of the system data stored in the first processor memory 41. The communication and comparison are performed after the scope 10 and the processor 30 are connected, and before the primary and secondary image processing commence; in other words, before the normal operation of the endoscope system 1 is performed.

When the version of the system data stored in the first scope memory 21 and the version of the system data stored in the first processor memory 41 are not the same, the scope controller 10 and the processor controller 40 write over (update) the older system data with the newer system data.

Then, by using parameters from the updated system data, the primary image processing and the secondary image processing are performed.

Writing over the system data is explained.

At first, the later (newer) version of the system data stored in either the first processor memory 41 or the first scope memory 21 is copied to either the second scope memory 22 or the second processor memory 42.

Then, the copied system data stored in either the second scope memory 22 or the second processor memory 42 is written over the earlier (older) version of the system data stored in either the first scope memory 21 or the first processor memory 41.

Specifically, when the system data stored in the first scope memory 21 is older than the system data stored in the first processor memory 41, the newer system data stored in the first processor memory 41 is copied to the second scope memory 22, and then the newer system data temporarily stored in the second scope memory 22 is overwritten onto the first scope memory 21.

In other words, after the system data is temporarily stored in the second scope memory 22, the older system data stored in the first scope memory 21 is replaced (written over) by the newer system data temporarily stored in the second scope memory 22.

Similarly, when the system data stored in the first processor memory 41 is older than the system data stored in the first scope memory 21, the newer system data stored in the first scope memory 21 is copied to the second processor memory 42, and then the newer system data temporarily stored in the second processor memory 42 is overwritten onto the first processor memory 41.

In other words, after the system data is temporarily stored in the second processor memory 42, the older system data stored in the first processor memory 41 is replaced (written over) by the newer system data temporarily stored in the second processor memory 42.

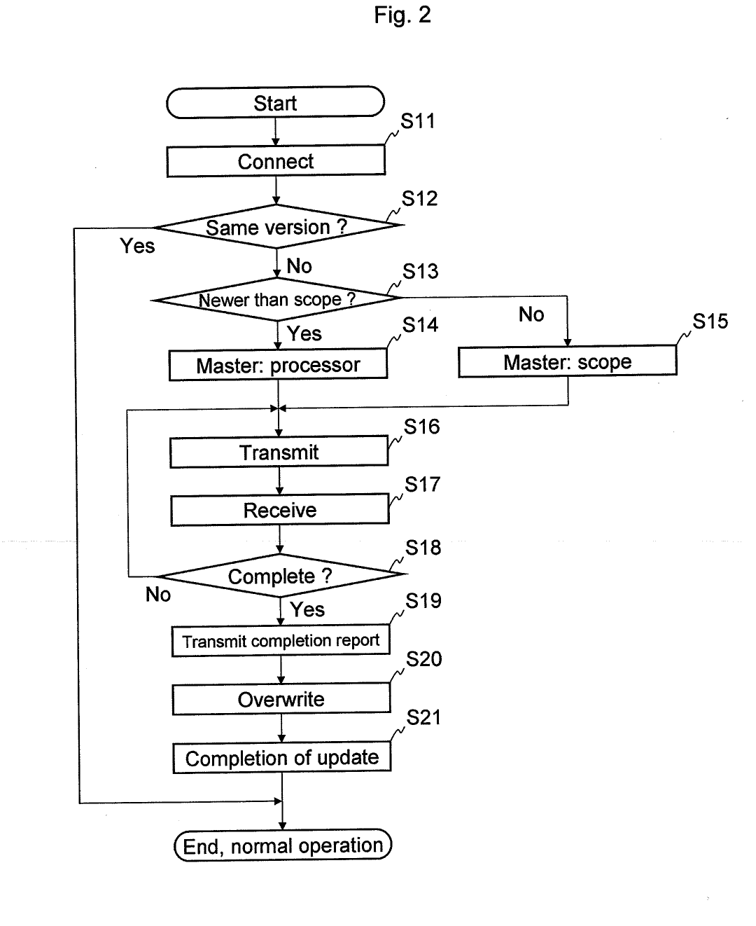

Next, the procedure for updating the system data is explained using the flowchart of FIG. 2.

When the scope 10 is connected to the processor 30 and when the main power supply of the endoscope system 1 is set to the ON state, the communication between the scope controller 20 and the processor controller 40 is performed in step S11.

Then, the version of the system data stored in the first scope memory 21 is compared to the version of the system data stored in the first processor memory 41.

In step S12, it is determined whether these versions are the same. Information regarding the version, such as the update timing or the like, is written on a header etc., of the system data. This information is used for comparison of the version.

When it is determined that these versions are the same, the system data cannot be updated, the operation for updating is therefore finished and the normal operation of the endoscope system 1 then becomes possible.

Otherwise, the operation continues to step S13.

In step S13, it is determined whether the version of the system data stored in the first processor memory 41 is newer than that in the first scope memory 21.

When it is determined that the version of the system data stored in the first processor memory 41 is newer than that in the first scope memory 21, the operation continues to step S14. Otherwise, the operation proceeds to step S15.

In addition, before the operation of step S13, the confirmation display indicating whether or not the system data should be updated may be displayed on the monitor 50, and then it may be determined by the user operating the input device 60 whether to update the system data.

In this case, the monitor 50 displays that one of either the system data in the first scope memory 21 or the system data in the first processor memory 41 is older than the other system data, and displays whether the other system data, which is the newer data, should be overwritten onto the older system data so that the older system data would be updated.

When the user operating the input device 60 determines to update the older system data, the operation proceeds to step S13, otherwise, the operation for updating is finished and the normal operation of the endoscope system 1 then becomes possible.

In step S14, the processor 30 is set to the master that transmits the newer system data stored in the first processor memory 41, and the scope 10 is set to the slave that receives the newer system data from the master (the processor 30).

Similarly, in step S15, the scope 10 is set to the master that transmits the newer system data stored in the first scope memory 21, and the processor 30 is set to the slave that receives the newer system data from the master (the scope 10).

In step S16, the newer system data stored in the primary memory (the first scope memory 21 or the first processor memory 41) of the master, is transmitted to the slave.

Specifically, when the processor 30 is set to the master, the newer system data stored in the first processor memory 41 is transmitted to the scope 10.

Similarly, when the scope 10 is set to the master, the newer system data stored in the first scope memory 21 is transmitted to the processor 30.

In step S17, the slave receives the newer system data from the master, and temporarily stores it in the secondary memory (the second scope memory 22 or the second processor memory 42) of the slave.

Specifically, when the scope 10 is set to the slave, the scope 10 receives the newer system data stored in the first processor memory 41 and temporarily stores it in the second scope memory 22.

Similarly, when the processor 30 is set to the slave, the processor 30 receives the newer system data stored in the first scope memory 21 and temporarily stores it in the second processor memory 42.

If the transmitting operation of the system data from the master to the slave is interrupted, a break in the memory caused by a writing error, etc., may occur so that it may affect the normal operation of the endoscope system 1. With this interruption, the main power supply of the endoscope system 1 may be set to the OFF state while the system data in the master is being transmitted to the slave.

Therefore, in order to prevent such an occurrence from adversely affecting the normal operation of the endoscope system 1, the newer system data in the master is not directly overwritten into the primary memory of the slave, in the first embodiment.

That is, the newer system data in the master is overwritten into the primary memory of the slave, through the secondary memory of the slave.

In step S18, the controller of the master determines whether the transmission of the system data from the master to the slave is completed.

Specifically, when the processor 30 is set to the master, the processor controller 40 determines whether the transmission of the system data from the first processor memory 41 to the scope 10 is completed.

Similarly, when the scope 10 is set to the master, the scope controller 20 determines whether the transmission of the system data from the first scope memory 21 to the processor 30 is completed.

When the transmission has not been completed, the operation in steps S16 and S17 is repeated. Otherwise, the operation continues to step S19.

In step S19, the controller of the master transmits the signal that shows the completion of the transmission of the system data to the slave (transmits the completion report).

Specifically, when the processor 30 is set to the master, the processor controller 40 transmits the signal that shows the completion of the transmission of the system data to the scope controller 20.

Similarly, when the scope 10 is set to the master, the scope controller 20 transmits the signal that shows the completion of the transmission of the system data to the processor controller 40.

In step S20, the controller of the slave copies the system data temporarily stored in the secondary memory of the slave and then overwrites it into the primary memory of the slave in order to update it.

Specifically, when the scope 10 is set to the slave, the scope controller 20 deletes the system data stored in the first scope memory 21, copies the system data temporarily stored in the second scope memory 22, and pastes the copied system data into the first scope memory 21.

Similarly, when the processor 30 is set to the slave, the processor controller 40 deletes the system data stored in the first processor memory 41, copies the system data temporarily stored in the second processor memory 42, and pastes the copied system data into the first processor memory 41.

Thus, the version of the system data stored in the first scope memory 21 and the version of the system data stored in the first processor memory 41 can be the same.

In step S21, the monitor 50 displays that the older system data stored in the primary memory of the slave has been updated to the newer version, and then the operation for updating is finished and the normal operation of the endoscope system 1 then becomes possible.

Specifically, when the scope 10 is set to the slave, the monitor 50 displays that the older system data stored in the first scope memory 21 has been updated so that the version of the system data stored in the first scope memory 21 has been change to the same as that of the system data stored in the first processor memory 41.

Similarly, when the processor 30 is set the slave, the monitor 50 displays that the older system data stored in the first processor memory 41 has been updated so that the version of the system data stored in the first processor memory 41 has been change to the same as that of the system data stored in the first scope memory 21.

When the normal operation of the endoscope system 1 becomes possible, the first image-processing unit 15 performs the primary image processing by using the appropriate parameters for the first image-processing unit 15 selected from among the system data stored in the first scope memory 21. Furthermore, the second image-processing unit 35 performs the secondary image processing by using the appropriate parameters for the second image-processing unit 35 selected from among the system data stored in the first processor memory 41.

Therefore, the older system data including the parameters for the primary image processing by the first image-processing unit 15 and the parameters for the secondary image processing by the second image-processing unit 35, which are stored in one of either the first scope memory 21 or the first processor memory 41, can be updated by using the newer system data stored in the other of the first scope memory 21 or the first processor memory 41.

Furthermore, because the older system data can be updated by connecting the scope 10 and the processor 30, the operation for updating can be simplified for the user compared to when the system data is updated by using an external device.

For example, if the scope 10 that stores the latest system data in the first scope memory 21 is prepared, the system data stored in the first processor memory 41 for all of the processors that may possibly be connected to this scope 10 can be updated.

Furthermore, the system data stored in the first scope memory 21 for all of the scopes that may possibly be connected to one of these updated processors can be updated.

In the first embodiment, it is explained that the system data are the parameters used for the image processing performed by the first image-processing unit 15 and the second image-processing unit 35.

However, the system data may be another set of data, for example it may be the firmware for the scope 10 and the processor 30.

In this case, an operation is performed that installs the updated firmware to the slave, after updating in step S20.

Furthermore, it is explained that the scope 10 has the second scope memory 22 for updating, and the processor 30 has the second processor memory 42 for updating.

In this case, the new version of the system data can be supplied both from the scope 10 to the processor 30 and from the processor 30 to the scope 10.

However, one of the scope 10 and the processor 30 may have the second memory for updating while the other may not have the second memory for updating.

In this case, the new version of the system data can be supplied either from the scope 10 to the processor 30 or from the processor 30 to the scope 10.

Next, the second embodiment is explained. In the first embodiment, the second scope memory 22 and the second processor memory 42 are volatile. However, in the second embodiment, the second scope memory 22 and the second processor memory 42 are non-volatile. The points that differ from the first embodiment are explained next.

An endoscope system 1 in the second embodiment comprises a scope 10, a processor 30, a monitor 50, and an input device 60, similarly to the first embodiment (see FIG. 1).

The scope 10 has an imaging unit 11 including an imaging sensor such as a CCD or the like, a first image-processing unit (image-processing circuit) 15 such as a DSP or the like, a scope controller 20, a first scope memory 21 for image processing, and a second scope memory 22 for updating. In the second embodiment, both the first scope memory 21 and the second scope memory 22 are non-volatile.

The processor 30 has an isolation circuit 31, a second image-processing unit (image-processing circuit) 35 such as a DSP or the like, a processor controller 40, a first processor memory 41 for image processing, and a second processor memory 42 for updating. In the second embodiment, both the first processor memory 41 and the second processor memory 42 are non-volatile.

The first image-processing unit 15 performs primary image processing such as a YC separation or the like, on the image signal obtained by the imaging unit 11.

The processor 30 performs secondary image processing on the image signal after the primary image processing, so as to generate the image (the video signal) that can be displayed on the monitor 50.

In the second embodiment, it is also defined that the first scope memory 21 and the first processor memory 41 are the primary memory, and that the second scope memory 22 and the second processor memory 42 are the secondary memory, similarly to the first embodiment.

The monitor 50 is connected to the processor 30. The monitor 50 displays the image in conformity with the standard of the predetermined video signal, upon which the primary image processing and the secondary image processing are performed by the scope 10 and the processor 30.

Furthermore, the input device 60 such as a keyboard or the like is connected to the processor 30.

The external memory that stores the image data, etc., based on the image signal, may be connected to the processor 30. Furthermore, the printer may also be connected to the processor 30.

Next, the details of the endoscope system 1 are explained.

The reflection of the photographic subject based on the illumination of the endoscope system 1 reaches the imaging sensor of the imaging unit 11 through the objective optical system (not depicted), and the optical image of the subject is imaged on the incident surface of the imaging sensor of the imaging unit 11. At the imaging sensor, the photoelectric conversion operation of the optical image is performed and then the image signal based on the optical image is output.

The image signal output from the imaging unit 11 is transmitted to the first image-processing unit 15 of the scope 10. The first image-processing unit 15 performs the primary image processing of the image signal, such as the YC separation that separates the luminance (Y) signal and the chrominance (C) signal of the image signal, etc.

The image signal after the primary image processing is transmitted to the second image-processing unit 35 of the processor 30, through the isolation circuit 31. The isolation circuit 31 protects the patient from electric shock, etc.

The second image-processing unit 35 performs the secondary image processing so as to generate the video signal that can be displayed on the monitor 50.

The first scope memory 21 stores system data that are used for the primary image processing by the first image-processing unit 15 and for the secondary image processing by the second image-processing unit 35. The system data are composed of parameters that are grouped by each model of scope that can be connected to the processor 30 and by each model of processor that can be connected to the scope 10.

The parameters include a gamma characteristic, an enhancement, a limit value of the luminance signal, etc.

The parameters among the system data that correspond to the active scope 10 that is presently connected to the processor 30 right are used for the primary image processing by the first image-processing unit 15.

Furthermore, the system data are also stored in the first processor memory 41. When it is determined by communication between the scope controller 20 and the processor controller 40 that either the system data in the first scope memory 21 or the system data in the first processor memory 41 is older than the other system data, the other system data, which is newer data, is written over the older system data so that the older system data is updated.

The first image-processing unit 15 reads out the parameters, which are necessary for the primary image processing, from the system data stored in the first scope memory 21, when the scope 10 is connected to the processor 30 and when the main power supply of the endoscope system 1 is set to the ON state.

The parameters, which are read by the first image-processing unit 15, are temporarily stored in the first image-processing unit 15 and are used for the primary image processing, while the scope 10 is connected to the processor 30 and while the main power supply of the endoscope system 1 is set to the ON state.

The second scope memory 22 is used for storing the system data stored in the first processor memory 41 in order to prepare for updating the system data stored in the first scope memory 21, when it is determined that the system data stored in the first scope memory 21 is older than the system data stored in the first processor memory 41.

The first processor memory 41 stores the system data, similarly to the first scope memory 21.

The second processor memory 42 is used for storing the system data stored in the first scope memory 21 in order to prepare for updating the system data stored in the first processor memory 41, when it is determined that the system data stored in the first processor memory 41 is older than the system data stored in the first scope memory 21.

The second image-processing unit 35 reads out the parameters, which are necessary for the secondary image processing, from the system data stored in the first processor memory 41, when the scope 10 is connected to the processor 30 and when the main power supply of the endoscope system 1 is set to the ON state.

The parameters, which are read by the second image-processing unit 35, are temporarily stored in the second image-processing unit 35 and are used for the secondary image processing, while the scope 10 is connected to the processor 30 and while the main power supply of the endoscope system 1 is set to the ON state.

In the second embodiment, the scope controller 10 and the processor controller 40 communicate with each other and compare the version of the system data stored in the first scope memory 21 to the version of the system data stored in the first processor memory 41. The communication and the comparison are performed while the scope 10 and the processor 30 are connected and the main power supply of the endoscope system 1 is set to the ON state. Specifically, the communication and the comparison are performed in parallel with the primary image processing by the first image-processing unit 15 and the secondary image processing by the second image-processing unit 35; in other words, in parallel with the normal operation of the endoscope system 1.

When the version of the system data stored in the first scope memory 21 and the version of the system data stored in the first processor memory 41 are not the same, the scope controller 10 and the processor controller 40 write over (update) the older system data with the newer system data.

By using parameters from the updated system data, the primary image processing and the secondary image processing are performed, after the main power supply of the endoscope system 1 is set to the ON state again.

Writing over the system data is explained.

At first, the later (newer) version of the system data stored in either the first processor memory 41 or the first scope memory 21 is copied to either the second scope memory 22 or the second processor memory 42.

Then, the copied system data stored in either the second scope memory 22 or the second processor memory 42 is written over the earlier (older) version of the system data stored in either the first scope memory 21 or the first processor memory 41.

Specifically, when the system data stored in the first scope memory 21 is older than the system data stored in the first processor memory 41, the newer system data stored in the first processor memory 41 is copied to the second scope memory 22, and then the newer system data stored in the second scope memory 22 is overwritten onto the first scope memory 21.

In other words, after the system data is stored in the second scope memory 22, the older system data stored in the first scope memory 21 is replaced (written over) by the newer system data stored in the second scope memory 22.

Similarly, when the system data stored in the first processor memory 41 is older than the system data stored in the first scope memory 21, the newer system data stored in the first scope memory 21 is copied to the second processor memory 42, and then the newer system data stored in the second processor memory 42 is overwritten onto the first processor memory 41.

In other words, after the system data is stored in the second processor memory 42, the older system data stored in the first processor memory 41 is replaced (written over) by the newer system data stored in the second processor memory 42.

When the main power supply of the endoscope system 1 is set to the OFF state while the system data is being transmitted to or stored in the second scope memory 22 or the second processor memory 42, storage of the system data in the second scope memory 22 or the second processor memory 42 is interrupted.

In this case, the interrupted storage process is resumed depending on the storage status of the system data stored in the second scope memory 22 or the second processor memory 42, when the main power supply of the endoscope system 1 is set to the ON state again.

Specifically, storing the remaining part of the system data that has not yet been stored in the second scope memory 22 or the second processor memory 42, is performed.

When another scope 10, which further stores newer system data compared to the system data that has been partly stored in the second processor memory 42, is connected to the processor 30, this newer system data is stored in the second processor memory 42 after deleting the system data that has been partly stored in the second processor memory 42.

Similarly, another processor 30, which further stores newer system data compared to the system data that has been partly stored in the second scope memory 22, is connected to the scope 10, this newer system data is stored in the second scope memory 22 after deleting the system data that has been partly stored in the second scope memory 22.

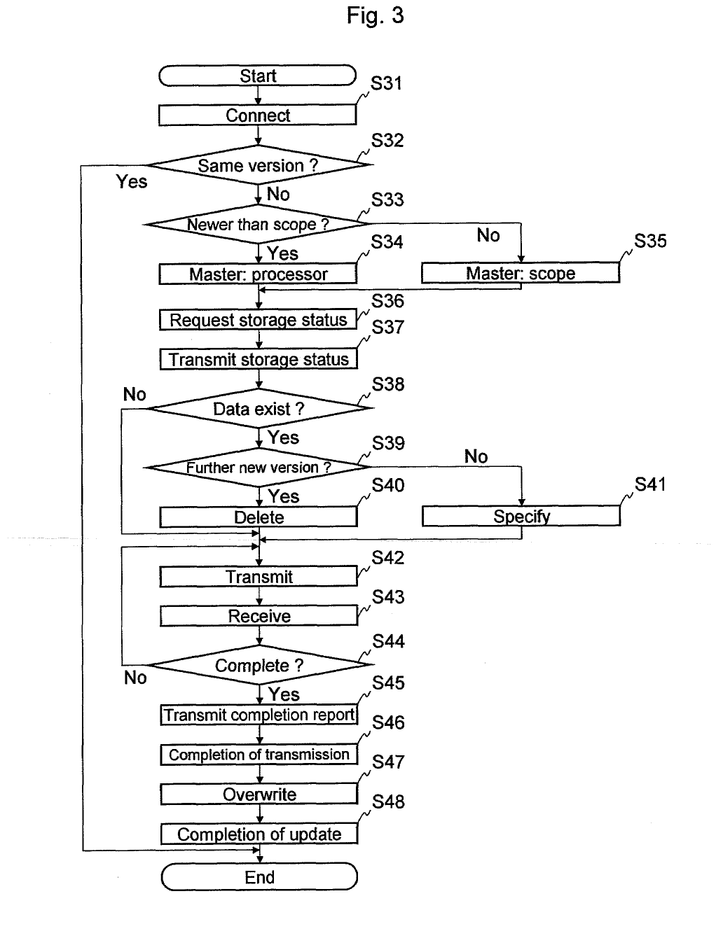

Next, the procedure for updating the system data is explained using the flowchart of FIG. 3.

When the scope 10 is connected to the processor 30 and when the main power supply of the endoscope system 1 is set to the ON state, the communication between the scope controller 20 and the processor controller 40 is performed in step S31.

The operation for updating the system data is performed, with the primary image processing by the first image-processing unit 15 and the secondary image processing by the second image-processing unit 35 being performed in parallel; in other words, with the normal operation of the endoscope system 1 being performed in parallel.

Then, the version of the system data stored in the first scope memory 21 is compared to the version of the system data stored in the first processor memory 41.

In step S32, it is determined whether these versions are the same. Information regarding the version, such as the update timing or the like, is written on the header etc., of the system data. This information is used for comparison of the version.

When it is determined that these versions are the same, the system data cannot be updated and the operation for updating is finished.

Otherwise, the operation continues to step S33.

In step S33, it is determined whether the version of the system data stored in the first processor memory 41 is newer than that in the first scope memory 21.

When it is determined that the version of the system data stored in the first processor memory 41 is newer than that in the first scope memory 21, the operation continues to step S34. Otherwise, the operation proceeds to step S35.

In addition, before the operation of step S33, the confirmation display indicating whether or not the system data should be updated may be displayed on the monitor 50, and then it may be determined by the user operating the input device 60 whether to update the system data.

In this case, the monitor 50 displays that one of either the system data in the first scope memory 21 or the system data in the first processor memory 41 is older than the other system data, and displays whether the other system data, which is newer data, should be overwritten onto the older system data so that the older system data would be updated.

When the user operating the input device 60 determines to update the older system data, the operation proceeds to step S33, otherwise, the operation for updating is finished.

In step S34, the processor 30 is set to the master that transmits the newer system data stored in the first processor memory 41, and the scope 10 is set to the slave that receives the newer system data from the master (the processor 30).

Similarly, in step S35, the scope 10 is set to the master that transmits the newer system data stored in the first scope memory 21, and the processor 30 is set to the slave that receives the newer system data from the master (the scope 10).

In step S36, the controller of the master transmits a command signal to the controller of the slave.

The command signal includes a signal for requesting the storage status of the system data stored in the secondary memory of the slave when the scope 10 and the processor 30 have been previously connected; in other words, for requesting how much system data has been received by the slave.

Specifically, when the processor 30 is set to the master, the processor controller 40 transmits the command signal for requesting the storage status of the system data stored in the second scope memory 22 to the scope controller 20.

Similarly, when the scope 10 is set to the master, the scope controller 20 transmits the command signal for requesting the storage status of the system data stored in the second processor memory 42 to the processor controller 40.

Because the second scope memory 22 and the second processor memory 42 are non-volatile, the system data partly stored in the second scope memory 22 or the second processor memory 42 is not deleted even when the main power supply of the endoscope system 1 is set to the OFF state.

Therefore, the receiving process of the system data can be executed even by multiple transmissions. The operation in step S36 is performed for confirming how much system data has been received by the secondary memory of the slave.

In step S37, the controller of the slave transmits the signal regarding the storage status of the system data to the controller of the master.

Specifically, when the scope 10 is set to the slave, the scope controller 20 transmits the signal regarding the storage status of the system data stored in the second scope memory 22 to the processor controller 40.

Similarly, when the processor 30 is set to the slave, the processor controller 40 transmits the signal regarding the storage status of the system data stored in the second processor memory 42 to the scope controller 20.

The storage status includes the information regarding whether a part of the system data is stored in the secondary memory of the slave.

When a part of the system data is stored in the secondary memory of the slave, the storage status further includes the information regarding the version of the system data partly stored in the secondary memory of the slave.

In step S38, the controller of the master determines whether a part of the system data is stored in the secondary memory of the slave, on the basis of the storage status of the system data stored in the secondary memory of the slave.

Specifically, when the processor 30 is set to the master, the processor controller 40 determines whether a part of the system data is stored in the second scope memory 22, on the basis of the storage status of the system data stored in the second scope memory 22.

Similarly, when the scope 10 is set to the master, the scope controller 20 determines whether a part of the system data is stored in the second processor memory 42, on the basis of the storage status of the system data stored in the second processor memory 42.

When the controller of the master determines that a part of the system data is stored in the secondary memory of the slave, the operation continues to step S39, otherwise, the operation proceeds to step S42.

In step S39, the controller of the master determines whether the version of the system data stored in the primary memory of the master is newer than the version of the system data partly stored in the secondary memory of the slave.

Specifically, when the processor 30 is set to the master, the processor controller 40 determines whether the version of the system data stored in the first processor memory 41 is newer than the version of the system data partly stored in the second scope memory 22.

Similarly, when the scope 10 is set to the master, the scope controller 20 determines whether the version of the system data stored in the first scope memory 21 is newer than the version of the system data partly stored in the second processor memory 42.

The current combination of the scope 10 and the processor 30 is the same as the previous combination of the scope 10 and processor 30, the version of the system data stored in the primary memory of the master is the same as the version of the system data partly stored in the secondary memory of the slave.

However, when the current combination of the scope 10 and the processor 30 changed from the previous combination of the scope 10 and processor 30, the version of the system data stored in the primary memory of the master may not be the same as the version of the system data partly stored in the secondary memory of the slave.

When the controller of the master determines that the version of the system data stored in the primary memory of the master is newer than the version of the system data partly stored in the secondary memory of the slave, it is determined that the system data partly stored in the secondary memory of the slave can be further updated, so that the operation continues to step S40. Otherwise, it is determined that the versions are the same and the operation proceeds to step S41.

In step S40, the controller of the master transmits a command to the controller of the slave to delete the system data partly stored in the secondary memory of the slave, because the new version of the system data can be stored so that the system data partly stored in the secondary memory of the slave becomes unnecessary.

Then, the system data partly stored in the secondary memory of the slave is deleted.

Specifically, when the processor 30 is set to the master, the processor controller 40 transmits the command to the scope controller 20 to delete the system data partly stored in the second scope memory 22. Then, the system data partly stored in the second scope memory 22 is deleted.

Similarly, when the scope 10 is set to the master, the scope controller 20 transmits the command to the processor controller 40 to delete the system data partly stored in the second processor memory 42. Then the system data partly stored in the second processor memory 42 is deleted.

In step S41, the controller of the master specifies the part of the system data that has yet to be stored in the secondary memory of the slave, on the basis of the storage status of the system data stored in the secondary memory of the slave.

In other words, the controller of the slave specifies the part of the system data that is necessary to transmit from the master to the slave.

Specifically, when the processor 30 is set to the master, the processor controller 40 specifies the part of the system data that is necessary to transmit from the first processor memory 41 to the second scope memory 22, on the basis of the storage status of the system data stored in the second scope memory 22.

Similarly, when the scope 10 is set to the master, the scope controller 20 specifies the part of the system data that is necessary to transmit from the first scope memory 21 to the second processor memory 42, on the basis of the storage status of the system data stored in the second processor memory 42.

For example, the case where the system data consists of 10 files is explained. At the previous connection between the scope 10 and processor 30, the slave has received the first, second, and third files. But, while the fourth file is being transmitted, in other words, before storing the fourth file in the secondary memory of the slave has been completed, the main power supply of the endoscope system 1 is set to the OFF state.

In this case, at the next connection between the scope 10 and the processor 30, the controller of the master specifies the fourth to tenth files as the part of the system data that is necessary to transmit.

Only the part of the system data that is specified as necessary to transmit in step S41 is transmitted.

In step S42, the system data is transmitted from the primary memory of the master to the secondary memory of the slave.

When the operation directly proceeds to step S42 from step S38 or when the operation proceeds to step S42 from step S40, all of the system data stored in the primary memory of the master is transmitted to the secondary memory of the slave.

When the operation continues to step S42 from step S41, the part of the system data stored in the primary memory of the master that has not been stored in the secondary memory of the slave is transmitted to the secondary memory of the slave.

Specifically, when the processor 30 is set to the master and when the operation directly proceeds to step S42 from step S38 or from step S40, all of the system data stored in the first processor memory 41 is transmitted to the second scope memory 22.

When the processor 30 is set to the master and when the operation continues to step S42 from step S41, the part of the system data stored in the first processor memory 41 that has not been stored in the second scope memory 22 is transmitted to the second scope memory 22.

Similarly, when the scope 10 is set to the master and when the operation directly proceeds to step S42 from step S38 or from step S40, all of the system data stored in the first scope memory 21 is transmitted to the second processor memory 42.

When the scope 10 is set to the master and when the operation continues to step S42 from step S41, the part of the system data stored in the first scope memory 21 that has not been stored in the second processor memory 42 is transmitted to the second processor memory 42.

In step S43, the slave receives the newer system data from the master and stores it in the secondary memory of the slave.

Specifically, when the scope 10 is set to the slave, the scope 10 receives the newer system data stored in the first processor memory 41 and stores it in the second scope memory 22.

Similarly, when the processor 30 is set to the slave, the processor 30 receives the newer system data stored in the first scope memory 21 and stores it in the second processor memory 42.

If the transmitting operation of the system data from the master to the slave is interrupted, a break in the memory caused by a writing error, etc., may occur so that it may affect the normal operation of the endoscope system 1. With this interruption, the main power supply of the endoscope system 1 may be set to the OFF state while the system data in the master is being transmitted to the slave.

Therefore, in order to prevent such an occurrence from adversely affecting the normal operation of the endoscope system 1, the newer system data in the master is not directly overwritten into the primary memory of the slave, in the second embodiment.

That is, the newer system data in the master is overwritten into the primary memory of the slave, through the secondary memory of the slave.

In step S44, the controller of the master determines whether the transmission of the system data from the master to the slave is completed.

Specifically, when the processor 30 is set to the master, the processor controller 40 determines whether the transmission of the system data from the first processor memory 41 to the scope 10 is completed.

Similarly, when the scope 10 is set to the master, the scope controller 20 determines whether the transmission of the system data from the first scope memory 21 to the processor 30 is completed.

When the transmission has not been completed, the operation in steps S42 and S43 is repeated. Otherwise, the operation continues to step S45.

In step S45, the controller of the master transmits the signal that shows the completion of the transmission of the system data to the controller of the slave (transmits the completion report).

Specifically, when the processor 30 is set to the master, the processor controller 40 transmits the signal that shows the completion of the transmission of the system data to the scope controller 20.

Similarly, when the scope 10 is set to the master, the scope controller 20 transmits the signal that shows the completion of the transmission of the system data to the processor controller 40.

In step S46, the information that shows the completion of the transmission of the system data from the master to the slave is displayed on the monitor 50.

Specifically, when the processor 30 is set to the master, the information that shows the completion of the transmission of the system data from the first processor memory 41 to the second scope memory 22 is displayed on the monitor 50.

Similarly, when the scope 10 is set to the master, the information that shows the completion of the transmission of the system data from the first scope memory 21 to the second processor memory 42 is displayed on the monitor 50.

In step S47, the controller of the slave cuts the system data stored in the secondary memory of the slave and then overwrites it into the primary memory of the slave in order to update it.

Specifically, when the scope 10 is set to the slave, the scope controller 20 deletes the system data stored in the first scope memory 21, cuts the system data stored in the second scope memory 22, and pastes the cut system data into the first scope memory 21.

Similarly, when the processor 30 is set to the slave, the processor controller 40 deletes the system data stored in the first processor memory 41, cuts the system data stored in the second processor memory 42, and pastes the cut system data into the first processor memory 41.

Thus, the version of the system data stored in the first scope memory 21 and the version of the system data stored in the first processor memory 41 can be the same.

Further, by cut-and-paste, the system data stored in the secondary memory of the slave is deleted.

The parameters, which are included in the system data updated in step S27, in other words, which are included in the system data that is newly stored in the primary memory of the slave, are used for the image processing after the main power supply of the endoscope system 1 is set to the ON state again.

Therefore, the parameters, which are included in the system data before updating in step S27, are used for the image processing until the main power supply of the endoscope system 1 is set to the ON state again.

In step S48, the monitor 50 displays that the older system data stored in the primary memory of the slave has been updated to the newer version and that the parameters that are included in the updated system data are used for the image processing after the main power supply of the endoscope system 1 is set to the ON state again, and then the operation for updating is finished.

Specifically, when the scope 10 is set to the slave, the monitor 50 displays that the older system data stored in the first scope memory 21 has been updated so that the version of the system data stored in the first scope memory 21 has been changed to the same as that of the system data stored in the first processor memory 41, and that the parameters that are included in the updated system data stored in the first scope memory 21 are used for the primary image processing after the main power supply of the endoscope system 1 is set to the ON state again.

Similarly, when the processor 30 is set the slave, the monitor 50 displays that the older system data stored in the first processor memory 41 has been updated so that the version of the system data stored in the first processor memory 41 has been changed to the same as that of the system data stored in the first scope memory 21, and that the parameters that are included in the updated system data stored in the first processor memory 41 are used for the secondary image processing after the main power supply of the endoscope system 1 is set to the ON state again.

In addition, if the operation for updating the system data is interrupted before completing the operation in step S45, the operation for updating restarts from step S31 after the main power supply of the endoscope system is set to the ON state again. With this interruption, the main power supply of the endoscope system 1 may be set to the OFF state.

When the model of the master is changed but the model of the slave does not change compared to the previous combination of the scope 10 and the processor 30, the operation for updating is continued.

Specifically, when the version of the system data stored in the primary memory of the master is newer than the version of the system data partly stored in the secondary memory of the slave, the operation proceeds to step S40 and then the operation for updating is performed.

When the version of the system data stored in the primary memory of the master is the same as the version of the system data partly stored in the secondary memory of the slave, the operation proceeds to step S41 and then the operation for updating is performed.

Therefore, the older system data including the parameters for the primary image processing by the first image-processing unit 15 and the parameters for the secondary image processing by the second image-processing unit 35, which are stored in one of either the first scope memory 21 or the first processor memory 41, can be updated by using the newer system data stored in the other of the first scope memory 21 or the first processor memory 41.

Furthermore, because the older system data can be updated by connecting the scope 10 and the processor 30, the operation for updating can be simplified for the user compared to when the system data is updated by using an external device.

For example, if the scope 10 that stores the latest system data in the first scope memory 21 is prepared, the system data stored in the first processor memory 41 for all of the processors that may possibly be connected to this scope 10 can be updated.

Furthermore, the system data stored in the first scope memory 21 for all of the scopes that may possibly be connected to one of these updated processors can be updated.

Furthermore, because the operation for updating is performed with the normal operation of the endoscope system 1 being performed in parallel in the second embodiment, the operation for updating does not limit the use conditions of the user. For example, even if the operation for updating is performed over an extended period of time, the use condition of user is not limited because the normal operation of the endoscope system 1 can be performed before completion of the operation for updating.

In particular, when the data size of the system data is large, the operation for updating may not be completed during a one-time use of the endoscope system 1.

However, in the second embodiment, it is not necessary to complete the operation for updating during a one-time use of the endoscope system 1. So, the operation for updating can be completed over the course of multiple operations.

Therefore, the operation for updating does not limit the use conditions of the user even if the data size of the system data is so large that it takes an extended period of time to perform the operation for updating.

Furthermore, when the operation for updating is performed over the course of multiple operations, the model as the master may not be the same at the time of every operation if the version of the system data is kept the same.

For example, in the case where a plurality of scopes 10 have the same version of system data in the first scope memory 21, the operation for updating the system data stored in the first processor memory 41 can be continuously performed by connecting one of these scopes 10 at random.

In the second embodiment, it is explained that the system data are the parameters used for the image processing performed by the first image-processing unit 15 and the second image-processing unit 35.

However, the system data may be another set of data, for example it may be the firmware for the scope 10 and the processor 30.

In this case, an operation is performed that installs the updated firmware to the slave, after updating in step S47.

The newly updated and installed firmware is used for the normal operation after the main power supply of the endoscope system 1 is set to the ON state again.

Furthermore, it is explained that the scope 10 has the second scope memory 22 for updating and the processor 30 has the second processor memory 42 for updating.

In this case, the new version of the system data can be supplied both from the scope 10 to the processor 30 and from the processor 30 to the scope 10.

However, one of the scope 10 and the processor 30 may have the second memory for updating while the other may not have the second memory for updating.

In this case, the new version of the system data can be supplied either from the scope 10 to the processor 30 or from the processor 30 to the scope 10.

Furthermore, the first scope memory 21 and the second scope memory 22 may be separated and composed of two memories, or they may be composed of one memory and two storage fields. The same can be said of the first processor memory 41 and the second processor memory 42.

In the case where the first scope memory 21 and the second scope memory 22 are composed of one memory, the number of components can be reduced and the scope 10 can be downsized. The same can be said of the first processor memory 41 and the second processor memory 42.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Applications Nos. 2008-131926 (filed on May 20, 2008) and 2008-132161 (filed on May 20, 2008) which are expressly incorporated herein by reference, in their entirety.

1. An endoscope system comprising:
a scope that has an imaging sensor, a first image-processing unit that performs primary image processing on an image signal obtained by said imaging sensor, a first scope memory for image processing, and a second scope memory for updating; said first scope memory being non-volatile, and said second scope memory being volatile; and
a processor that has a second image-processing unit that performs secondary image processing on said image signal after said primary image processing, a first processor memory for image processing, and a second processor memory for updating; said first processor memory being non-volatile, and said second processor memory being volatile;
said first scope memory storing system data that includes parameters used for said primary and secondary image processing, or includes firmware for said scope and said processor;
said first processor memory storing the system data;
said second scope memory being used for temporarily storing the system data stored in said first processor memory, when it is determined that the system data stored in said first scope memory is older than the system data stored in said first processor memory;
said second processor memory being used for temporarily storing the system data stored in said first scope memory, when it is determined that the system data stored in said first processor memory is older than the system data stored in said first scope memory;
the system data temporarily stored in said second scope memory being overwritten onto said first scope memory, after the system data is temporarily stored in said second scope memory; and
the system data temporarily stored in said second processor memory being overwritten onto said first processor memory, after the system data is temporarily stored in said second processor memory.

2. The endoscope system according to claim 1, wherein it is determined whether the system data stored in said first scope memory is older than the system data stored in said first processor memory, after said scope and processor have been connected, and before said primary and secondary image processing commence.

3. An endoscope system comprising:
a scope that has an imaging sensor, a first image-processing unit that performs primary image processing on an image signal obtained by said imaging sensor, and a scope memory for image processing, said scope memory being non-volatile; and
a processor that has a second image-processing unit that performs secondary image processing on said image signal after said primary image processing, a first processor memory for image processing, and a second processor memory for updating; said first processor memory being non-volatile, and said second processor memory being volatile;
said scope memory storing system data that includes parameters used for said primary and secondary image processing, or includes firmware for said scope and said processor;
said first processor memory storing the system data;
said second processor memory being used for temporarily storing the system data stored in said scope memory, when it is determined that the system data stored in said first processor memory is older than the system data stored in said scope memory; and
the system data temporarily stored in said second processor memory being overwritten onto said first processor memory, after the system data is temporarily stored in said second processor memory.

4. An endoscope system comprising:
a scope that has an imaging sensor, a first image-processing unit that performs primary image processing on an image signal obtained by said imaging sensor, a first scope memory for image processing, and a second scope memory for updating; said first scope memory being non-volatile, and said second scope memory being volatile; and
a processor that has a second image-processing unit that performs secondary image processing on said image signal after said primary image processing, and a processor memory for image processing; said processor memory being non-volatile;
said first scope memory storing system data that includes parameters used for said primary and secondary image processing, or includes firmware for said scope and said processor;
said processor memory storing the system data;
said second scope memory being used for temporarily storing the system data stored in said processor memory, when it is determined that the system data stored in said first scope memory is older than the system data stored in said processor memory; and
the system data temporarily stored in said second scope memory being overwritten onto said first scope memory, after the system data is temporarily stored in said second scope memory.

5. An endoscope system comprising:
a scope that has an imaging sensor, a first image-processing unit that performs primary image processing on an image signal obtained by said imaging sensor, a first scope memory for image processing, and a second scope memory for updating; said first scope memory and said second scope memory being non-volatile; and
a processor that has a second image-processing unit that performs secondary image processing on said image signal after said primary image processing, a first processor memory for image processing, and a second processor memory for updating; said first processor memory and said second processor memory being non-volatile;
said first scope memory storing system data that includes parameters used for said primary and secondary image processing, or includes firmware for said scope and said processor;
said first processor memory storing the system data;
said second scope memory being used for storing the system data stored in said first processor memory, when it is determined that the system data stored in said first scope memory is older than the system data stored in said first processor memory;
said second processor memory being used for storing the system data stored in said first scope memory, when it is determined that the system data stored in said first processor memory is older than the system data stored in said first scope memory;
the system data stored in said second scope memory being overwritten onto said first scope memory, after the system data is stored in said second scope memory; and
the system data stored in said second processor memory being overwritten onto said first processor memory, after the system data is stored in said second processor memory.

6. The endoscope system according to claim 5, wherein it is determined whether the system data stored in said first scope memory is older than the system data stored in said first processor memory, after said scope and processor have been connected, with said primary and secondary image processing being performed in parallel.

7. The endoscope system according to claim 6, wherein when storage of the system data to the second scope memory or said second processor memory is interrupted, said storage is resumed depending on a storage status of the system data stored in said second scope memory or said second processor memory.

8. An endoscope system comprising:
a scope that has an imaging sensor, a first image-processing unit that performs primary image processing on an image signal obtained by said imaging sensor, and a scope memory for image processing; said scope memory being non-volatile; and
a processor that has a second image-processing unit that performs secondary image processing on said image signal after said primary image processing, a first processor memory for image processing, and a second processor memory for updating; said first processor memory and said second processor memory being non-volatile;
said scope memory storing system data that includes parameters used for said primary and secondary image processing, or includes firmware for said scope and said processor;
said first processor memory storing the system data;
said second processor memory being used for storing the system data stored in said scope memory, when it is determined that the system data stored in said first processor memory is older than the system data stored in said scope memory; and
the system data stored in said second processor memory being overwritten onto said first processor memory, after the system data is stored in said second processor memory.

9. An endoscope system comprising:
a scope that has an imaging sensor, a first image-processing unit that performs primary image processing on an image signal obtained by said imaging sensor, a first scope memory for image processing, and a second scope memory for updating; said first scope memory and said second scope memory being non-volatile; and
a processor that has a second image-processing unit that performs secondary image processing on said image signal after said primary image processing, and a processor memory for image processing; said processor memory being non-volatile;
said first scope memory storing system data that includes parameters used for said primary and secondary image processing, or includes firmware for said scope and said processor;
said processor memory storing the system data;
said second scope memory being used for storing the system data stored in said processor memory, when it is determined that the system data stored in said first scope memory is older than the system data stored in said processor memory; and
the system data stored in said second scope memory being overwritten onto said first scope memory, after the system data is stored in said second scope memory.
